(19) United States
(12) Patent Application Publication
(10) Pub. No.: US 2008/0298848 A1
(43) Pub. Date: Dec. 4, 2008

(54) DEVELOPING DEVICE AND IMAGE FORMING APPARATUS HAVING THE SAME

(75) Inventor: Sang Don LEE, GWACHEON-SI (KR)

Correspondence Address: DLA PIPER US LLP, P. O. BOX 9271, RESTON, VA, 20195, US

(73) Assignee: SAMSUNG ELECTRONICS CO., LTD., GYEONGGI-DO (KR)

(21) Appl. No.: 12/105,841

(22) Filed: Apr. 18, 2008

(30) Foreign Application Priority Data
Jun. 4, 2007 (KR) 10-2007-0054430

(51) Int. Cl. G03G 15/09

(52) U.S. Cl. 399/274

(57) ABSTRACT

A developing device having an improved regulating member to regulate the thickness of a developing agent layer and consequently, achieving easy fabrication, reduced fabrication costs and/or reduction in the size of the developing device, and an image forming apparatus having the same, is described. The developing device includes a developing container, which contains a developing agent therein, and which has an opening. A developing roller is installed at the opening of the developing container. A regulator regulates the thickness of a developing agent layer on an outer surface of the developing roller. The regulator includes a main regulating member, which maintains a first distance between an end of the main regulating member and the outer surface of the developing roller, and a preliminary regulating member integrally formed with the developing container at a position ahead of the main regulating member along the rotating direction of the developing roller. The preliminary regulating member maintains a second distance between an end of the preliminary regulating member and the outer surface of the developing roller, the second distance being larger than the first distance.

### CROSS-REFERENCE TO RELATED APPLICATION

This application claims the benefit of Korean Patent Application No. 2007-0054430, filed on Jun. 4, 2007, in the Korean Intellectual Property Office, the disclosure of which is incorporated herein by reference.

### BACKGROUND OF THE INVENTION

1. Field of the Invention

The present invention relates to a developing device of an image forming apparatus, and, more particularly, to a developing device, which includes an improved regulating member to regulate the thickness of a developing agent layer on a developing roller, and an image forming apparatus having the same.

2. Description of the Related Art

An image forming apparatus using an electronic photography method, such as a laser printer, copier, facsimile, etc., includes a developing device to supply a developing agent to a photosensitive member, so as to develop an electrostatic latent image on the photosensitive member into a visible image.

Korean Patent Laid-Open Publication No. 2003-0027706 to Kikuchi (“Kikuchi”) discloses one type of the above-described developing device. The disclosed developing device includes a developing roller (designated as a “magnet roller” in Kikuchi), a blade as a secondary or final thickness regulating member to provide a uniform thickness to a developing agent layer on an outer surface of the developing roller, and a developer stopping member as a primary thickness regulating member. The developer stopping member initially regulates the thickness of the developing agent layer within the developing container, and also causes a predetermined amount of developing agent to be gathered in the space between the blade and the developer stopping member. This allows the blade to achieve a more uniform final thickness of the developing agent layer.

However, the above-described conventional developing device has a problem in that the developer stopping member, which is used to primarily regulate the thickness of the developing agent layer, must be installed in the developing container. This complicates fabrication, increases fabrication costs, and makes size reduction of the developing device difficult.

### SUMMARY OF THE INVENTION

Accordingly, it is an aspect of the invention to provide a developing device, which includes an improved regulating member to regulate the thickness of a developing agent layer, thereby achieving easy fabrication and reduced fabrication costs and reducing the size of the developing device, and an image forming apparatus having the same.

Additional aspects and/or advantages of the invention will be set forth in part in the description which follows and, in part, will be obvious from the description, or may be learned by practice of the invention.

In accordance with an aspect of the invention, the above and/or other aspects can be achieved by the provision of a developing device comprising: a developing container, which contains the developing agent therein, and which has an opening; a developing roller installed at the opening of the developing container; and a regulator to regulate the thickness of a developing agent layer on an outer surface of the developing roller, wherein the regulator comprises: a main regulating member, the main regulating member maintaining a first distance between an end of the main regulating member and the outer surface of the developing roller; and a preliminary regulating member integrally formed with the developing container at a position ahead of the main regulating member along the direction of a rotation of the developing roller, the preliminary regulating member maintaining a second distance between an end of the preliminary regulating member and the outer surface of the developing roller, the second distance being larger than the first distance.

The preliminary regulating member may be integrally formed, in the vicinity of the opening, with the developing container, and the main regulating member may be mounted at the outside of the opening of the developing container and spaced apart from the preliminary regulating member.

The developing device may further comprise: a delivery member to agitate, and to deliver, the developing agent in the container toward the developing roller, and the delivery member and the developing roller may maintain a third distance therebetween, the third distance being larger than the second distance.

In accordance with another aspect of the present invention, there is provided an image forming apparatus comprising: a body; a photosensitive member installed in the body; and a developing device to supply a developing agent to the photosensitive member, the developing device may comprise: a developing container, which contains a developing agent therein and has an opening; a developing roller installed at the opening of the developing container; and a regulator to regulate the thickness of a developing agent layer on an outer surface of the developing roller, and the regulator may comprise: a main regulating member, the main regulating member maintaining a first distance between an end of the main regulating member and the outer surface of the developing roller; and a preliminary regulating member integrally formed with the developing container at a position ahead of the main regulating member along the direction of rotation of the developing roller, the preliminary regulating member maintaining a second distance between an end of the preliminary regulating member and the outer surface of the developing roller, the second distance being larger than the first distance.

### BRIEF DESCRIPTION OF THE DRAWINGS

These and/or other aspects and advantages of the exemplary embodiments of the invention will become apparent and more readily appreciated from the following description of the embodiments, taken in conjunction with the accompanying drawings, of which:

FIG. 1 is a sectional view showing the schematic configuration of an image forming apparatus in accordance with the present invention;

FIG. 2 is a detailed view of an image forming unit in FIG. 1; and

FIG. 3 is a detailed view of the portion III in FIG. 2.

### DETAILED DESCRIPTION OF THE PREFERRED EMBODIMENTS

Reference will now be made in detail to an exemplary embodiment of the present invention, examples of which are illustrated in the accompanying drawings, wherein like reference numerals refer to like elements throughout. The embodiments are described below to explain the present invention by referring to the figures.

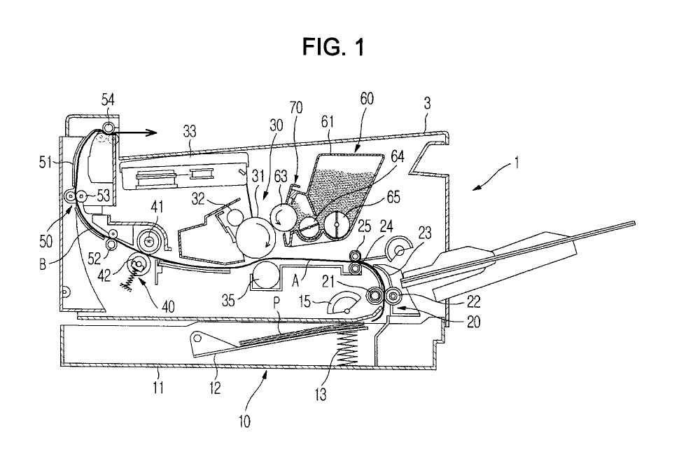

FIG. 1 is a sectional view showing the schematic configuration of an example of an image forming apparatus in accordance with the present invention. In this example, the image forming apparatus may be, e.g., a laser printer. The image forming apparatus includes a paper supply unit 10, in which paper P is loaded, a delivery unit 20 to deliver the paper P, an image forming unit 30 to form an image on the paper P, a fixing unit 40 to fix the image transferred onto the paper P, and a paper discharge unit 50 to discharge the paper P.

The paper supply unit 10 is installed to a lower portion of the body 1. The paper supply unit 10 includes a paper supply tray 11, which may be a detachably mounted cassette, and a pressing plate 12 and a pressing spring 13, which are used to push the paper P in the paper supply tray 11 to a pickup roller 15 located above the paper supply unit 10. The pressing spring 13 is installed below the pressing plate 12 and is used to push the pressing plate 12 toward the pickup roller 15. By operation of the pressing spring 13 and pressing plate 12, the paper P on the pressing plate 12 is brought into contact with the pickup roller 15. The rotation of the pickup roller 15 picks up the paper P one sheet at a time, to supply the paper P to the delivery unit 20.

The delivery unit 20 delivers the paper P, picked up by the pickup roller 15, along a printing route A. The delivery unit 20 includes a delivery roller 21, a delivery backup roller 22, a delivery guide 23 defining the printing route A, and a register roller 24 and a register backup roller 25 to align a tip end of the paper P in the course of delivering the paper P.

The image forming unit 30 includes a photosensitive member 31 located along the printing route A, a charge roller 32 to charge the photosensitive member 31, a Laser Scanning Unit (LSU) 33 to irradiate a laser beam onto the charged photosensitive member 31 according to an image signal so as to form an electrostatic latent image on the surface of the photosensitive member 31, a developing device 60 to supply a developing agent to the electrostatic latent image formed on the photosensitive member 31 so as to obtain a visible image, and a transfer roller 35 to transfer the image formed on the photosensitive member 31 onto the paper P. The photosensitive member has a negative charge as it is electrically charged by the charge roller 32. Then, if the LSU 33 irradiates a laser beam to the photosensitive member 31, an electrostatic latent image is formed on the surface of the photosensitive member 31. To obtain the visible image, the developing device 60 attaches a developing agent, having a negative charge, to the electrostatic latent image on the photosensitive member 31. The transfer roller 35, which has a positive charge, transfers the developing agent attached to the photosensitive member 31 onto the paper P, to form an image on the paper P.

The fixing unit 40 is provided at an exit side of the printing route A. The fixing unit 40 includes a heating roller 41 and a pressing roller 42. While the paper P passes through a gap between the heating roller 41 and the pressing roller 42, the heating roller 41 and pressing roller 42 apply heat and pressure to the developing agent (image) transferred onto the paper P, thereby allowing the developing agent to be bonded to the paper P.

The paper discharge unit 50 delivers the printed paper P, having passed through the printing route A, to a discharge opening 3 at the top of the body 1. The paper discharge unit 50 includes a paper discharge guide 51 defining a paper discharge route B, and a plurality of paper discharge rollers 52, 53, and 54 arranged in the paper discharge route B.

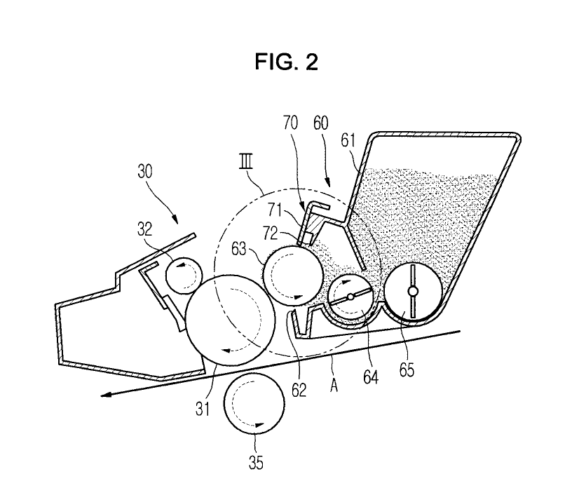

The developing device 60 of the image forming unit 30, as shown in FIG. 2, includes a developing container 61 and a developing roller 63. The developing container 61 contains the developing agent therein and has an opening 62 toward the photosensitive member 31. In an embodiment, the developing agent may be, e.g., two-component developing agent that includes a mixture of colorant particles and carrier particles. The developing agent may further be magnetically charged, e.g., by turboelectric effect. The developing roller 63 is installed at the opening 62 of the developing container 61 such that it rotates in close vicinity to the photosensitive member 61. The developing roller 63 mat be magnetically charged by a magnetic field generator (not shown) such as a magnet, etc. As a result, the developing agent in the developing container 61 can be supplied to an outer surface of the photosensitive member 31 in a state wherein it is attached to an outer surface of the developing roller 63. The developing device 60 further includes spiral delivery members 64 and 65 and a regulator 70. The spiral delivery members 64 and 65 rotate in the developing container 61 to agitate the developing agent, and to simultaneously deliver the developing agent to the developing roller 63. The regulator 70 regulates the thickness of a developing agent layer attached to the outer surface of the developing roller 63.

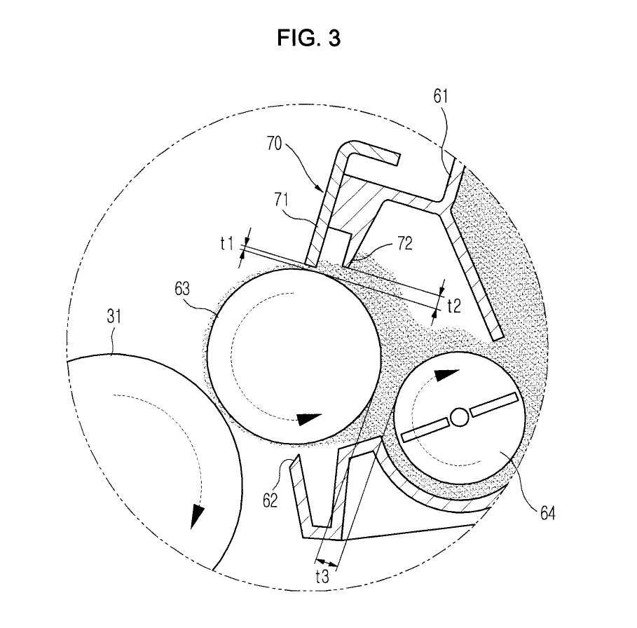

The regulator 70 is used to provide a uniform thickness to the developing agent layer, which may be irregularly attached to the outer surface of the developing roller 63, and consequently, determines a final thickness of the developing agent layer that will be transmitted to the photosensitive member 31. The regulator 70, as shown in FIG. 3, includes a main regulating member 71 and a preliminary regulating member 72. The main regulating member 71 has a flat plate shape and may be mounted at the outside of the opening 62 of the developing container 61. The preliminary regulating member 72 is integrally formed with the developing container 61 at a position (in the developing container 61) ahead or upstream of the main regulating member 71 along the rotating direction of the developing roller 63 (shown by the arrow of FIG. 3).

The main regulating member 71 is installed to maintain a first distance t1 between an end of the main regulating member 71 and the outer surface of the developing roller 63. The preliminary regulating member 72 is spaced apart from the main regulating member 71 and is installed to maintain a second distance t2 between an end of the preliminary regulating member 72 and the outer surface of the developing roller 63, the second distance t2 being larger than the first distance t1. The main regulating member 71 may be in the form of a blade that extends along the axial direction of the developing roller 63. The preliminary regulating member 72 may be a plate member that extends substantially parallel to the main regulating member 71 such that the opposing surfaces of the preliminary regulating member 72 and the main regulating member 71 run substantially parallel to each other.

The delivery member 64 is installed close to the developing roller 63 to maintain a third distance t3 with the developing roller 63, the third distance t3 being larger than the second distance t2. It is preferable that the first distance t1 be about 0.4˜0.9 mm, the second distance t2 be about 1.0˜1.5 mm, and the third distance t3 be about 2.0˜2.5 mm.

The delivery member 64 delivers the developing agent received in the developing container 61 to draw up the developing agent toward the developing roller 63 by rotation thereof, thereby allowing the developing agent to be attached to the outer surface of the developing roller 63. When the developing agent is attached to the developing roller 63 within the developing container 61, the developing agent forms a thick and irregular layer on the developing roller 63. In particular, when the amount of developing agent is small, the developing agent, attached to the developing roller 63 by the above-described delivery operation of the delivery member 64, forms an irregular thickness layer according to a difference in the amount of developing agent between a wing portion and a valley portion of the delivery member 64.

The preliminary regulating member 72 primarily regulates the thickness of the irregular developing agent layer attached to the developing roller 63, to provide a more uniform thickness to the developing agent layer along the longitudinal direction of the developing roller 63. After the thickness of the developing agent layer is primarily regulated to some extent by the preliminary regulating member 72, the main regulating member 71 regulates the thickness of the developing agent layer, to achieve a final uniform thickness of the developing agent layer that will be transmitted to the photosensitive member 31.

The preliminary regulating member 72 is integrally formed with the developing container 61 by injection molding, etc. during the fabrication of the developing container 61. By integrally forming the preliminary regulating member 72 with the developing container 61, it is unnecessary to install a separate regulating member in the developing container. This reduces the number of elements to be separately assembled, and enables easy fabrication of the developing device with reduced fabrication costs. Further, the developing device can be reduced in size.

As apparent from the above description, the present invention provides a developing device, in which a preliminary regulating member, which is used to primarily regulate the thickness of a developing agent layer within a developing container, is integrally formed with a developing container. The use of the integrally formed preliminary regulating member has the effects of reducing the number of elements, and consequently, achieving easy fabrication and reduced fabrication costs, and reducing the size of the developing device.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A developing device, comprising: a developing container, which contains a developing agent therein, and which has an opening; a developing roller installed at the opening of the developing container; and a regulator to regulate the thickness of a developing agent layer on an outer surface of the developing roller,
wherein the regulator comprises a main regulating member disposed such that the main regulating member maintains a first distance between an end of the main regulating member and the outer surface of the developing roller; and a preliminary regulating member integrally formed with the developing container at a position ahead of the main regulating member along the rotating direction of the developing roller, the preliminary regulating member maintaining a second distance between an end of the preliminary regulating member and the outer surface of the developing roller, the second distance being larger than the first distance.

2. The developing device according to claim 1, wherein
the preliminary regulating member is integrally formed, in the vicinity of the opening, with the developing container, and
the main regulating member is mounted at the outside of the opening of the developing container, and is spaced apart from the preliminary regulating member.

3. The developing device according to claim 1, further comprising:
a delivery member disposed in the developing container to agitate, and to deliver, the developing agent in the developing container toward the developing roller,
wherein the delivery member and the developing roller maintaining a third distance therebetween, the third distance being larger than the second distance.

4. The developing device according to claim 1, wherein:
said first distance is between 0.4˜0.9 mm, the second distance is between 1.0˜1.5 mm, and the third distance is between 2.0˜2.5 mm.

5. The developing device according to claim 1, wherein:
The main regulating member comprises a blade that extends along an axial direction of the developing roller, and
wherein the preliminary regulating member comprises a plate member that extends substantially parallel to the main regulating member such that opposing surfaces of the preliminary regulating member and the main regulating member run substantially parallel to each other.

6. The developing device according to claim 1, wherein:
the developing roller is magnetically charged.

7. The developing device according to claim 6, wherein:
the developing agent is magnetically charged.

8. The developing device according to claim 1, wherein:
the developing agent comprises colorant particles and carrier particles.

9. The developing device according to claim 8, wherein:
the developing agent is magnetically charged.

10. An image forming apparatus, comprising: a body; a photosensitive member installed in the body; and a developing device to supply a developing agent to the photosensitive member,
wherein the developing device comprises: a developing container, which contains a developing agent therein, and which has an opening; a developing roller installed at the opening of the developing container; and a regulator to regulate the thickness of a developing agent layer on an outer surface of the developing roller, and
wherein the regulator comprises a main regulating member disposed such that the main regulating member maintains a first distance between an end of the main regulating member and the outer surface of the developing roller; and a preliminary regulating member integrally formed with the developing container at a position ahead of the main regulating member along a rotating direction of the developing roller, the preliminary regulating member maintaining a second distance between an end of the preliminary regulating member and the outer surface of the developing roller, the second distance being larger than the first distance.

11. The image forming apparatus according to claim 10, wherein
the preliminary regulating member is integrally formed, in the vicinity of the opening, with the developing container, and
the main regulating member is mounted at the outside of the opening of the developing container, and is spaced apart from the preliminary regulating member.

12. The image forming apparatus according to claim 10, wherein
the developing device further comprises a delivery member disposed in the developing container to agitate, and to deliver, the developing agent in the developing container toward the developing roller,
the delivery member and the developing roller maintaining a third distance therebetween, the third distance being larger than the second distance.

13. The image forming apparatus according to claim 10, wherein
said first distance is between 0.4˜0.9 mm, the second distance is between 1.0˜1.5 mm, and the third distance is between 2.0˜2.5 mm.

14. The image forming apparatus according to claim 10, wherein
The main regulating member comprises a blade that extends along an axial direction of the developing roller, and
wherein the preliminary regulating member comprises a plate member that extends substantially parallel to the main regulating member such that opposing surfaces of the preliminary regulating member and the main regulating member run substantially parallel to each other.

15. The image forming apparatus according to claim 10, wherein
the developing roller is magnetically charged.

16. The image forming apparatus according to claim 15, wherein
the developing agent is magnetically charged.

17. The image forming apparatus according to claim 10, wherein
the developing agent comprises colorant particles and carrier particles.

18. The developing device according to claim 17, wherein:
the developing agent is magnetically charged.

19. A developing device, comprising:
a developing container including a frame, which defines an internal volume of the developing container, a developing agent being stored in the internal volume, and an opening;
a developing roller rotatably disposed in the opening of the developing container; and
a regulator including at least a first and a second regulating members spaced apart from each other, the second regulating member is integrally formed with the frame, and being disposed within the internal volume upstream of the first regulating member along a direction of rotation of the developing roller, the first regulating member being disposed outside said internal volume.

20. The developing device according to claim 19, wherein:
the first regulating member includes an end of the first regulating member opposing an outer surface of the developing roller at a first distance, and
wherein the second regulating member includes an end of the second regulating member that opposes the outer surface of the developing roller at a second distance, the second distance being larger than the first distance.
